(19) United States
(12) Patent Application Publication
(10) Pub. No.: US 2025/0152321 A1
(43) Pub. Date: May 15, 2025

(54) RETAINING NECK BAND

(71) Applicant: North Carolina State University, Raleigh, NC (US)

(72) Inventor: Patricia Secoura, Raleigh, NC (US)

(21) Appl. No.: 18/509,829

(22) Filed: Nov. 15, 2023

(51) Int. Cl. A61D 9/00; A61D 7/00

(52) U.S. Cl. CPC A61D 9/00; A61D 7/00

(57) ABSTRACT

A system, method, and device for retaining an implanted medical device is disclosed, the device including: a sleeve body extending circumferentially around a first longitudinal axis. The sleeve body defines a first aperture on a first end of the sleeve body and a second aperture on a second end of the sleeve body. The second end is spaced apart longitudinally from the first end of the sleeve body. The device further includes a sheath coupled to an inner surface of the sleeve body and extending circumferentially around a second longitudinal axis. The sheath defines a third aperture on a first end of the sheath and a fourth aperture on a second end of the sheath. The second end of the sheath is spaced apart from the first end of the sheath.

### BACKGROUND

The present disclosure relates generally to systems, methods, and devices for retaining a medical device adjacent to the neck of a living subject. Generally, medical devices may be permanent or semi-permanent such that they must be retained or protected from external forces some of the time. Such medical devices may also require periodic inspection and/or cleaning to prevent infection.

Accordingly, there is an on-going need in the art for devices and methods for reliably and consistently retaining an implanted medical device while allowing for periodic inspection.

### SUMMARY

Implanted medical devices may include any permanent or semi-permanent device, tube, pump, transmitter, port, or electronic module. For example, such medical devices include the following non-limiting examples: an esophagostomy tube, a glucose monitoring device, a vagus nerve stimulator, a radiotelemetry transmitter, a temperature device, and an osmotic pump. Such devices may be implanted on a living subject, for example, an animal (e.g., domesticated animals, including but not limited to, dogs, cats, guinea pigs, sheep, goats, horses, pigs, cows, or ruminants).

Esophagostomy tubes are placed frequently in veterinary medicine to aid in feeding and medicating living subjects (e.g., domesticated animals) that have medical issues affecting their appetite, their ability to eat, or their willingness to be medicated. When the esophagostomy tube (or “e-tube”) is placed, it needs to be protected from external forces that could pull it out before it is no longer needed. Especially in the case of animals who may inadvertently remove the device, retaining the e-tube in the desired location (e.g., adjacent to the neck of the animal) is preferable. Furthermore, the skin around the stoma may require daily inspection and cleaning to prevent infections, which is the most common complication. Therefore, despite requiring adequate protection and retainment, the e-tube should also be easily and quickly accessible.

Existing devices for retaining esophagostomy tubes fail to provide a reliable, consistent, and user-friendly device. For example, existing esophagostomy tube collars include a wide, thickly padded collar with a keyhole through which the tube exits for access and is secured to the outside of the collar with a hook-and-loop fastener (e.g., Velcro). The thickness of existing tube collars restricts movement of the head and prevents air flow, contributing to infections of the stoma (the hole the tube exits through the skin). The hook-and-loop fasteners may stick to an animal's hair, and they wear out over time, resulting in an unsecured tube. Furthermore, the added structure of the hook-and-loop fastener reduces the ability to machine wash the device. The design also discourages the owner from inspecting and cleaning the stoma daily due to the difficulty of detaching and reattaching the collar under the animal's chin. This leads to various complications including premature removal of the tube.

Therefore, provided herein are improved systems, methods, and devices for retaining a medical device in a desired location. For example, the systems, methods, and devices of this disclosure provide a retaining neck collar configured to retain an esophagostomy tube on an animal's neck while allowing for easy access to the stoma.

In one aspect, a device for retaining an implanted medical device (e.g., an esophagostomy tube, a glucose monitoring device, a vagus nerve stimulator, a radiotelemetry transmitter, a temperature logging device, and/or a osmotic pump) is disclosed, the device including: a sleeve body extending circumferentially around a first longitudinal axis. The sleeve body defines a first aperture on a first end of the sleeve body and a second aperture on a second end of the sleeve body. The second end is spaced apart longitudinally from the first end of the sleeve body. The device further includes a sheath coupled to an inner surface of the sleeve body and extending circumferentially around a second longitudinal axis. The sheath defines a third aperture on a first end of the sheath and a fourth aperture on a second end of the sheath. The second end of the sheath is spaced apart from the first end of the sheath.

In another aspect, a method of retaining an medical device implanted on the neck of a living subject (e.g., an esophagostomy tube on a dog) is disclosed, the method including: providing a retaining device, the device including: a sleeve body extending circumferentially around a first longitudinal axis, the sleeve body defining a first aperture on a first end of the sleeve body and a second aperture on a second end of the sleeve body, wherein the second end is spaced apart longitudinally from the first end of the sleeve body; and a sheath coupled to an inner surface of the sleeve body and extending circumferentially around a second longitudinal axis, the sheath defining a third aperture on a first end of the sheath and a fourth aperture on a second end of the sheath, wherein the second end of the sheath is spaced apart from the first end of the sheath. The method further includes placing the retaining device on a neck of an animal by stretching out a circumference of the sleeve body to fit over a head of the animal. The method further includes folding back a section of the sleeve body to expose a portion of the inner surface of the sleeve body and the sheath. The method further includes inserting the medical device (e.g., esophagostomy tube) into the sheath.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

FIG. 1A shows a top view of a neck band device for retaining an implanted medical device, according to one implementation.

FIG. 1B shows a top view of the device of FIG. 1A with a cutaway portion for detail.

FIG. 1C shows an image of retaining neck bands, according to one implementation.

FIG. 2A shows a retaining neck band fit onto the neck of the animal, according to one implementation.

FIG. 2B shows the retaining neck band of FIG. 2A in a different configuration.

FIG. 2C shows an image of an example neck band on an animal, according to one implementation.

FIG. 2D shows an image of the neck band of FIG. 2C in a different configuration.

FIG. 3 shows an image of a neck band, according to one implementation.

FIGS. 4A-4H show a series of images displaying the method and process of fitting a retaining neck band onto an animal subject, according to one implementation.

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

### DETAILED DESCRIPTION

Referring generally to the figures, a retaining neck collar is shown, according to various implementations. According to some implementations, the neck collar is configured to secure and protect a medical device implanted permanently or semi-permanently on a living subject. For example, the neck collar may retain an esophagostomy tube, a glucose monitoring device, a vagus nerve stimulator, a radiotelemetry transmitter, a temperature logging device, and/or an osmotic pump. According to some implementations, the neck collar is configured to provide easy and quick access to the stoma of the implanted medical device (e.g., for inspection and/or cleaning).

In one example, a retaining neck collar is provided for retaining an esophagostomy tube (“e-tube”) implanted in the neck of a living subject (e.g., a feeding tube for a dog). The esophagostomy tube may include a feeding adaptor on a distal end of the tube. The retaining neck collar, or band, for the esophagostomy tube may include a ring of stretchy microfiber material with an inner sleeve made with no rip nylon sewn midway on the inside along one side of the band. The band is slidable over an animal's head to position the inner sleeve adjacent to an animal's neck. The fabric of the band may be rolled back to expose the inner sleeve. The feeding adaptor of the esophagostomy tube is insertable into the sleeve, wherein the fabric may be rolled back into place. In this arrangement, the e-tube is adequately retained on the neck of the animal.

In some implementations, the esophagostomy tube neck band comprises a soft, stretchy material (e.g., an athletic fabric stretchable in one or more directions). For example, the materials used in this disclosure may have properties as defined by the standard test methods described in each of (i) ASTM Designation D2594/D2594M-21-Standard Test Method for Stretch Properties of Knitted Fabrics Having Low Power; and (ii) ASTM Designation D6614/D6614M-20-Standard Test Method for Stretch Properties of Textile Fabrics-CRE Method, each of which are incorporated herein by reference. The materials of this disclosure may be described with reference to the industry standards and definitions laid out in ASTM Designation D4850-23-Standard Terminology Relating to Fabrics and Fabric Test Methods, herein incorporated by reference.

In some implementations, the materials of this disclosure are knitted fabrics having a fabric stretch in the range of 5% to 200% in one or both of the wale and course direction. In some implementations, the materials of this disclosure are knitted fabrics having a fabric growth in the range of 0% to 10% in one or both of the wale and course direction. In some implementations, the materials of this disclosure are woven fabrics having a fabric stretch in the range of 5% to 200%. In some implementations, the materials of this disclosure are woven fabrics having a fabric growth in the range of 0% to 10%. In some implementations, the materials of this disclosure are nonwoven fabrics or composite fabrics exhibiting adequate material properties for the purposes herein described.

In some implementations, the material of the neck band allows for good airflow, does not restrict movement of the head, has no fasteners, and/or allows for the feeding adaptor to be easily accessed while remaining secure when not in use. In some implementations, because the band is pulled back to reveal the inner sheath holding the feeding adaptor, the medical professional or pet owner will see the stoma at each use and will be more likely to maintain the stoma, which will prevent infections. In some implementations, the neck band is also fully washable/dryable.

The neck band of this disclosure may have a length, width, diameter, circumference, thickness, and other dimensions configured to conform to the neck area of an animal subject. The width may correspond to the side-to-side distance of the neck band when the neck band is flat and relaxed. The height or length may correspond to the end-to-end length/height from one opening to another when the neck band is flat and relaxed, or the end-to-end length/height of a channel/tube extending from one opening to another. The diameter may correspond to the diameter of a tube/channel of the neck band when the neck band forms a cylindrical shape.

The neck band is stretchable between two configurations—a first, or relaxed, configuration and a second, or stretched, configuration. The relaxed configuration may have a diameter and/or a circumference matching the diameter and/or circumference of an animal's neck, while the stretched configuration may have a diameter and/or circumference greater each of the diameter and/or circumference of the animal's neck and the diameter and/or circumference of the relaxed configuration. The neck band may be provided in a variety of sizes, including, for example, extra-small, small, medium, large, and extra-large. In some implementations, the length/height of the tube is 9.5 inches for small, medium and large bands, and 19 inches for extra-large bands. In some implementations, a neck band of this disclosure may have a length/height in the range of 1 inch to 24 inches. In some implementations, the width or diameter of the neck band is as follows: small is 4.5 inches, the medium is 6.5 inches, the large is 8 inches and the extra-large is 9.75 inches. In some implementations, a neck band of this disclosure may have a width or diameter in the range of 4 inches to 24 inches.

The inner sleeve may be sewn or otherwise coupled to the neck band (e.g., via adhesive, buttons, zippers, other fasteners, or integrally formed with the neck band). The inner sleeve may be positioned in the middle of the length of the neck band (or the tube defined thereby) and oriented perpendicular to the tube's length. The inner sleeve may be 2 inches wide×5.5 long for small, medium and large band, and 6 inches long for extra-large bands.

Various objects, aspects, features, and advantages of the disclosure will become more apparent and better understood by referring to the following examples.

### Example Neck Band Structure and Operation

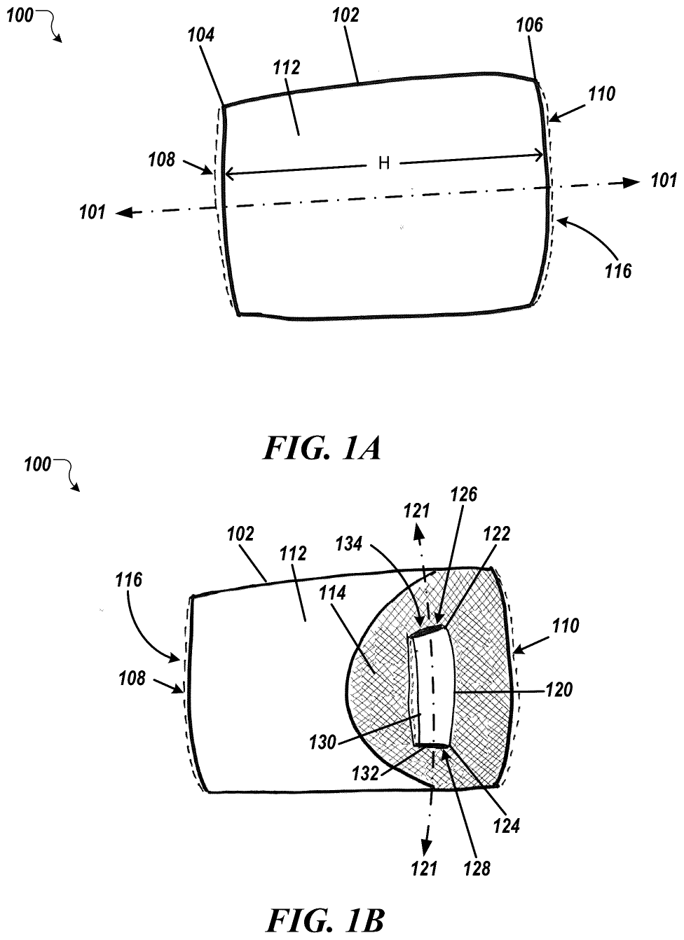

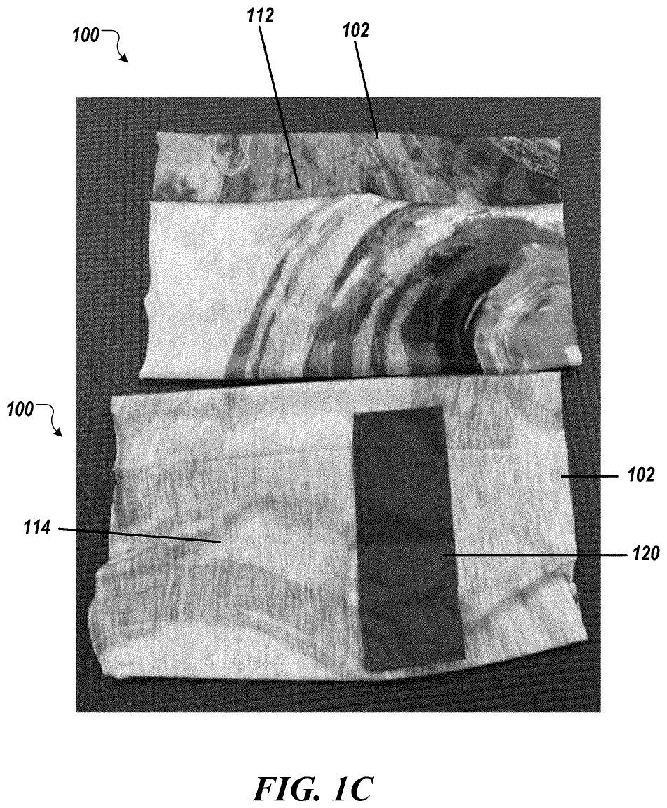

FIG. 1A and 1B show a device for retaining an implanted medical device. As shown, the device is a neck band 100 for retaining an esophagostomy tube 10. FIG. 1A shows a top view of the neck band 100 in a flat and relaxed configuration, while FIG. 1B shows a top view of the neck band 100 in the flat and relaxed configuration with a cutaway portion for detail.

The neck band 100 includes a sleeve body 102 extending from a first end 104 to a second end 106 of the sleeve body 102. The second end 106 of the sleeve body 102 is opposite and spaced apart longitudinally from the first end 104. The sleeve body 102 also extends circumferentially around a first longitudinal axis 101. The sleeve body 102 defines a first aperture 108 on the first end 104 of the sleeve body 102 and a second aperture 110 on the second end 106 of the sleeve body 102, the second aperture 110 being opposite of the first aperture 108.

The sleeve body 102 includes an outer surface 112 and an inner surface 114 opposite of the outer surface 112. As shown, the outer surface 112 is visible in FIG. 1A, while the inner surface 114 is visible in the cutaway area of FIG. 1B. The inner surface 114 of the sleeve body 102 defines a main channel 116 extending from the first aperture 108 to the second aperture 110 along the first longitudinal axis 101.

The first aperture 108 may be a cranial opening configured to face the head of an animal subject when the neck band 100 is positioned onto the animal's neck (e.g., wherein the main channel 116 includes the neck of the animal). The second aperture 110 may be a caudal opening configured to face the back and posterior of the animal subject when the neck band 100 is positioned onto the animal's neck.

The neck band 100 further includes a sheath 120 coupled to the inner surface 114 of the sleeve body 102. The sheath 120 extends from a first end 122 of the sheath 120 to a second end 124 of the sheath 120. The first end 122 of the sheath 120 is opposite and spaced apart longitudinally from the second end 124 of the sheath 120 along a second longitudinal axis 121. The sheath 120 extends circumferentially around the second longitudinal axis 121.

The sheath 120 defines a third aperture 126 on the first end 122 of the sheath 120 and a fourth aperture 128 on the second end 124 of the sheath 120, the fourth aperture 128 being opposite and spaced apart from the third aperture 126 along the second longitudinal axis 121.

The sheath 120 includes an outer surface 130 and an inner surface 132 opposite of the outer surface 130. A portion of the outer surface 130 is coupled to the inner surface 114 of the sleeve body 102 to couple the sheath 120 to the sleeve body 102. For example, the sheath 120 is sewn onto the sleeve body 102 using a thread.

The inner surface 132 of the sheath 120 defines a secondary channel 134. The secondary channel 134 extends from the third aperture 126 to the fourth aperture 128 along the second longitudinal axis 121. The sheath 120 and the associated secondary channel 134 are sized and configured to accept and retain a medical device (e.g., the esophagostomy tube 10 having a feeding adaptor 14 on a distal end thereof).

The second longitudinal axis 121 of the sheath 120, and the associated secondary channel 134, are oriented perpendicular to the first longitudinal axis 101 of the sleeve body 102 and the associated main channel 116 thereof. Thus, the main channel 116 of the sleeve body 102 is not aligned longitudinally with the secondary channel 134 of the sheath 120. In other words, the secondary channel 134 of the sheath 120 is oriented along the circumference of the inner surface 114 of the sleeve body 102. In other implementations, the sheath and the second longitudinal axis are oriented transverse to the sleeve body and the first longitudinal axis.

An image of example retaining neck bands of this disclosure is shown in FIG. 1C. As shown, one device (e.g., a neck band 100) is shown with the outer surface 112 visible, while another device (e.g., a neck band 100) is shown flipped inside out with the inner surface 114 and the sheath 120 visible.

The neck band 100, including the sleeve body 102, includes a stretchable, breathable fabric configured to slide over the head and onto the neck of an animal. For example, the sleeve body may comprise a stretch woven fabric capable of at least 20% stretch in either warp or filling direction.

The sleeve body 102 of the neck band 100 is stretchable between a first, or relaxed, configuration and a second, of stretched, configuration. In the first configuration, the sleeve body 102 has a first circumference measured along the sleeve body 102 around the first longitudinal axis 101 (e.g., in a direction perpendicular to the first longitudinal axis 101). In the second configuration, the sleeve body 102 has a second circumference measured along the sleeve body 102 around the first longitudinal axis 101 (e.g., in a direction perpendicular to the first longitudinal axis 101). The second circumference is larger than the first circumference. In other words, the diameter of the main channel 116 is larger in the second configuration than the diameter of the main channel 116 in the first configuration. Stretching the sleeve body 102 from the first configuration to the second configuration may be used, for example, to fit the neck band 100 over the head and onto the neck of the animal.

When moving the sleeve body 102 from the first configuration to the second configuration, a length or height of the sleeve body 102 measured longitudinally from the first end 104 and to the second end 106 may be reduced. The length or height also corresponds to the end-to-end distance of the main channel 116 measured from the first aperture 108 to the second aperture 110. The length or height of the sleeve body 102 in FIG. 1A is marked as “H”.

In some implementations, the material of the sleeve body is stretchable in only a single direction (e.g., to increase the circumference about the first longitudinal axis) such that the dimensions of the material in other directions stays the same (e.g., the height of the sleeve body may stay the same in the first and second configurations). In other implementations, the material of the sleeve body is stretchable in one direction such that the dimensions of the material in other directions change proportional to the stretch in the first direction. For example, the material of the sleeve body may be stretched in a first direction to increase the circumference about the first longitudinal axis, which may, in turn, reduce the height of the sleeve body a proportional amount (e.g., a 1:1 ratio, a 1:2 ratio, or another ratio depending on the material). Therefore, in some implementations, a first height of the sleeve body in the first configuration is greater than a second height of the sleeve body in the second configuration.

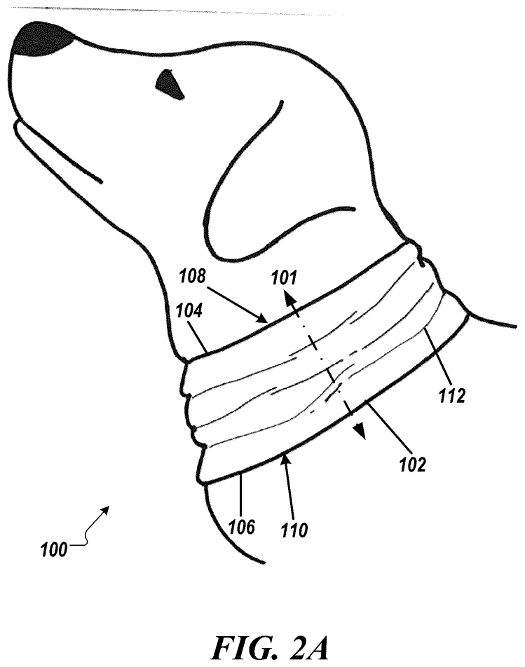

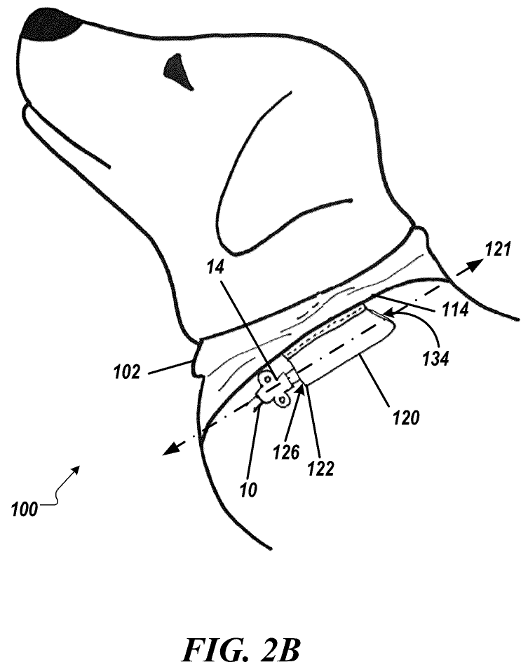

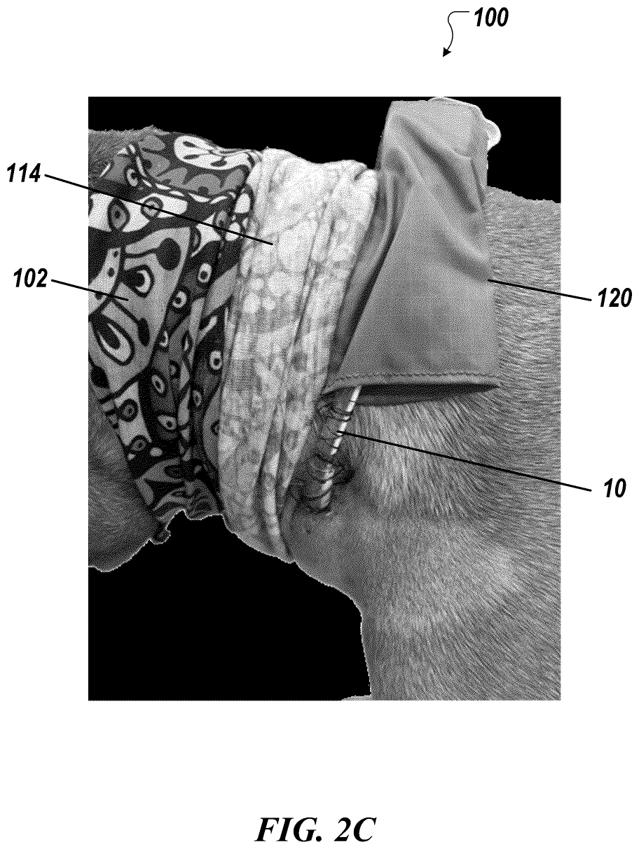

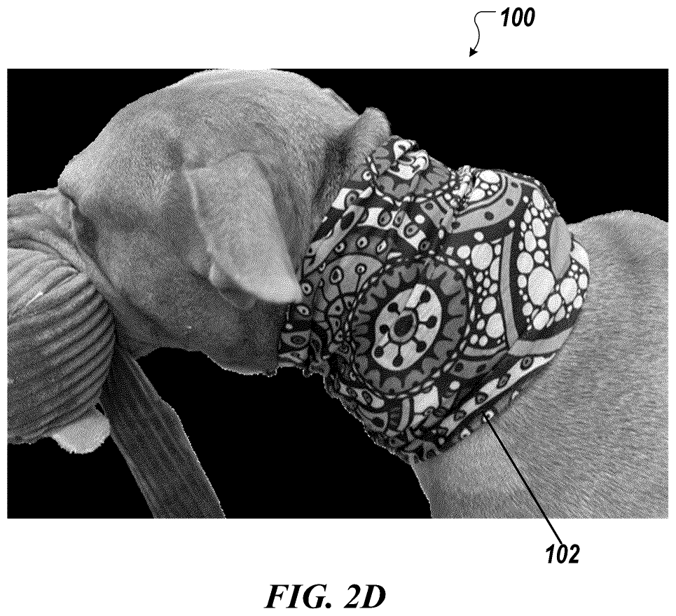

To fit the neck band 100 onto the animal (e.g., an animal having a feeding tube implanted in the neck), the sleeve body 102 is stretched from the first configuration to the second configuration to fit over the head of the animal and onto the neck of the animal. This arrangement is shown in FIG. 2A, wherein the neck band 100 has been fit onto the neck of the animal. As shown, the outer surface 112 of the sleeve body 102 is facing outward from the animal. The first end 104 and the first aperture 108 face the head of the animal, while the second end 106 and the second aperture 110 face towards the body of the animal. However, in other implementations, the neck band is reversable. In other implementations, the orientation of the neck band can be reversed such that the first end and the second end may be oppositely arranged (e.g., the neck band may be symmetrical from the first end to the second end).

In operation, the sleeve body 102 is movable between a placement configuration and an access configuration. The placement configuration is defined by the inner surface 114 of the sleeve body 102 being adjacent to the neck of the animal while the outer surface 112 faces away from the neck of the animal. The placement configuration is shown in FIG. 2A.

The access configuration is defined by a section of the sleeve body 102 being folded (or rolled) outwardly from the first longitudinal axis 101 to expose (i) a portion of the inner surface 114 of the sleeve body 102 and (ii) at least one end of the sheath 120. The access configuration is shown in FIG. 2B. As shown in FIG. 2B, an esophagostomy tube 10 is implanted in the animal's neck. In the access configuration, the esophagostomy tube 10 may be inserted into or removed from the sheath 120. Additionally, in the access configuration, the surgical site (e.g., the stoma) may be inspected and cleaned (e.g., by replacing any gauze or bandages).

As shown in FIG. 2B, the esophagostomy tube 10 is inserted into the third aperture 126 on the first end 122 of the sheath 120. The esophagostomy tube 10 is disposed within the secondary channel 134 of the sheath 120. Once the esophagostomy tube 10 is properly secured by the sheath 120, and any cleaning or inspection processes have been completed, the neck band 100 is moved back to the placement configuration. Once back in the placement configuration, the animal is free to move their head around and generally perform daily activities while the esophagostomy tube 10 is properly secured by the sheath 120 of the neck band 100.

FIG. 2B also depicts how the transverse longitudinal axes between the sleeve body 102 and the sheath 120 provide an advantageous structure and function of the neck band 100. As shown, the first longitudinal axis 101 of the sleeve body 102 generally follows the direction of the animal's head and neck. However, the esophagostomy tube 10 implanted in the animal's neck sticks out from the neck in a direction necessarily different from the animal's head and neck direction. By providing a sheath 120 having a second longitudinal axis 121 perpendicular to (or generally transverse to) the first longitudinal axis 101 of the sleeve body 102, the esophagostomy tube 10 is more closely aligned to the sheath 120. This arrangement allows for efficient and simple placement of the esophagostomy tube 10 in the sheath 120 without excess movement or bending of the esophagostomy tube 10.

### Example Implementation of the Retaining Neck Band

FIG. 2C shows an image of an example implementation of the neck band 100. The image shows a dog having an implanted esophagostomy tube 10 in the neck of the dog. The neck band 100 is fit onto the dog's neck and is shown in the access configuration wherein a portion of the sleeve body 102 is folded back to expose the inner surface 114 of the sleeve body 102 and the sheath 120. The esophagostomy tube 10 is disposed inside the sheath 120.

FIG. 2D shows an image of the same dog with the same neck band 100 of FIG. 2C. The neck band 100 in FIG. 2D is in the placement configuration wherein the sleeve body 102 is unfolded to retain the esophagostomy tube 10 and the sheath 120. As shown, the sleeve body 102 fits firmly to the neck of the dog to adequately secure the esophagostomy tube 10 and to avoid slipping the neck band 100 off of the dog. However, the sleeve body 102 is stretchable and is not so firm as to prevent the dog from moving their head or participating in regular daily activities.

### Alternative Configurations of the Retaining Neck Band

The retaining neck band of this disclosure is contemplated to comprise a variety of sizes to fit a variety of animals with varied neck sizes. In some implementations, the circumference of the sleeve body measured around the first longitudinal axis is in a range of 9 to 20 inches. In some implementations, the height of the sleeve body measured from the first end to the second end of the sleeve body is in a range of 4 to 10 inches.

In some implementations, the sheath of this disclosure is sized and shaped to accept and retain a different implanted medical device. For example, in some implementations, the sheath may be sized and shape to retain a glucose monitoring device, a vagus nerve stimulator, a radiotelemetry transmitter, a temperature logging device, or an osmotic pump.

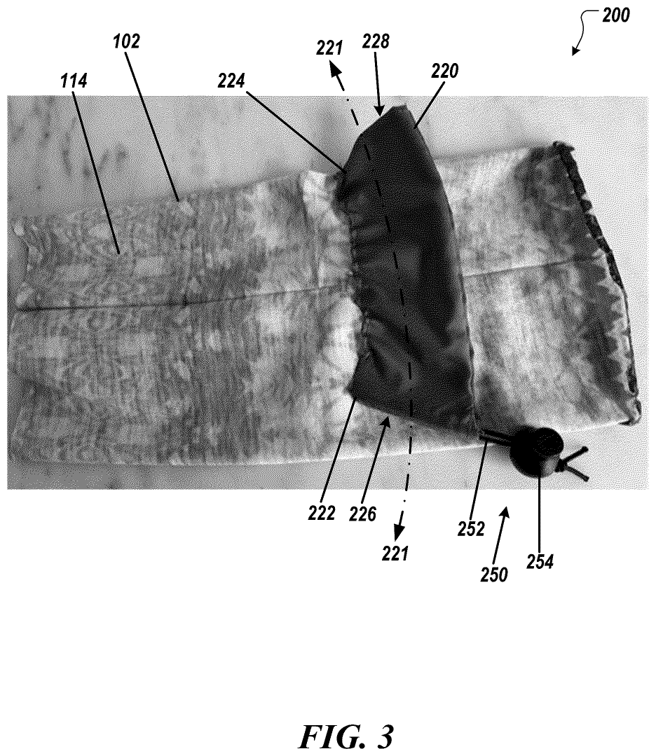

In some implementations, the retaining neck band further includes a device or structural element for aiding in the retention of one or both of the sleeve body and the sheath. For example, FIG. 3 shows a neck band 200, which is substantially similar to the neck band 100 of FIG. 1A, except as described below.

The neck band 200 includes a sleeve body 102 and a sheath 220. The neck band 200 is shown in FIG. 3 flipped inside out to show the inner surface 114 of the sleeve body 102 and the sheath 220 of the neck band 200. The sheath 220 extends from a first end 222 of the sheath 220 to a second end 224 of the sheath. The first end 222 of the sheath 220 is opposite and spaced apart longitudinally from the second end 224 of the sheath 220 along a second longitudinal axis 221. The sheath 220 extends circumferentially around the second longitudinal axis 221. The sheath 220 defines a third aperture 226 on the first end 222 of the sheath 220 and a fourth aperture 228 on the second end 224 of the sheath 220, the fourth aperture 228 being opposite and spaced apart from the third aperture 226 along the second longitudinal axis 221.

The sheath 220 includes a cord stop 250 on the first end 222 of the sheath 220. The cord stop 250 includes a cord 252 threaded through the sheath 220 on the first end 222 around the third aperture 226. The cord stop 250 further includes a cord retainer 254 coupled to the cord 252 and configured to retain the cord 252 at a desired position. The cord stop 250 is generally moveable to extend or retract the cord 252 out from or into the cord retainer 254 to expand or contract the size of the third aperture 226. The cord stop 250 may be used to reduce the circumference of the third aperture 226 of the sheath 220 (e.g., to retain an esophagostomy tube therein with a higher retaining force than that of the sheath 220 alone).

In other implementations, the cord stop may be placed on either end of the sheath. In other implementations, a cord stop may be placed on either end of the sleeve body to reduce a circumference thereof. In other implementations, an elastic band may take the place and function of the cord stop, the elastic band being coupled to or integrally formed on one or more sides of the sheath. In other implementations, an elastic band is coupled to one or more sides of the sleeve body (e.g., integrally formed elastic sections or portions on either end of the sleeve body to better retain the neck band and secure it on the neck of the animal).

### Example Process for Fit and Operation

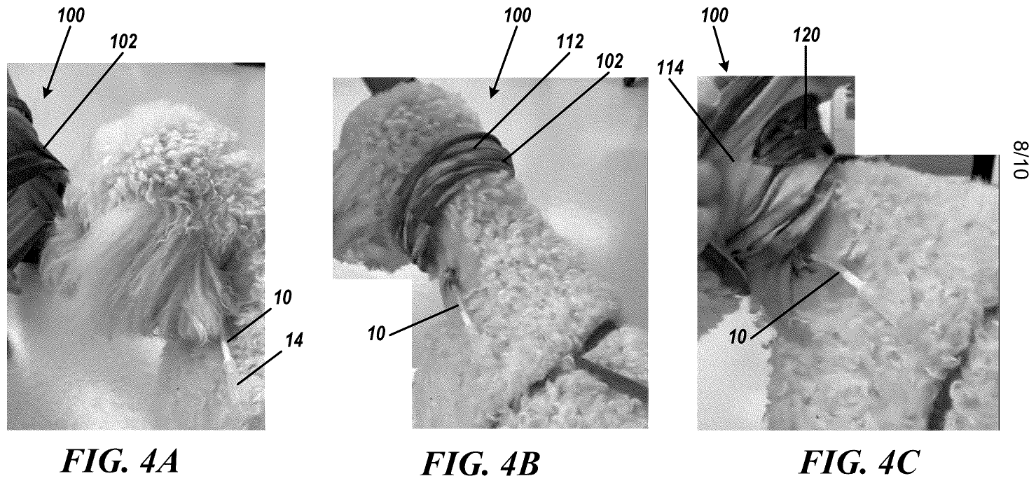

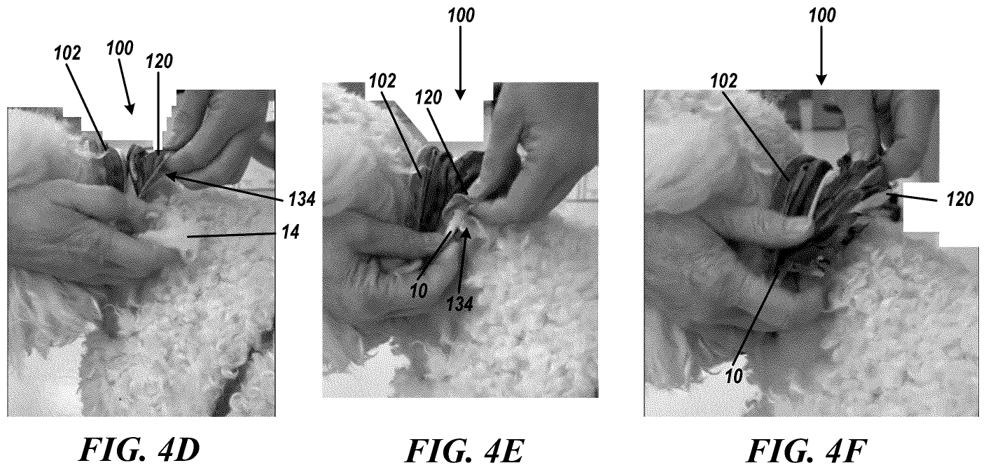

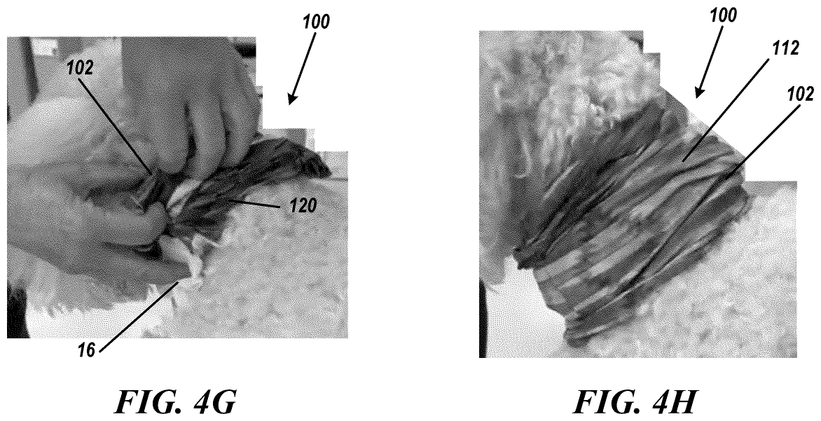

FIGS. 4A-4H show a series of images displaying the method and process of fitting a retaining neck band onto an animal subject. The neck band shown in FIGS. 4A-4H may be, for example, the neck band 100 of FIGS. 1A-1B.

FIG. 4A shows an image of a dog having an esophagostomy tube 10 implanted and sticking out from the neck. The esophagostomy tube 10 includes a feeding adaptor 14 on a distal end thereof. The neck band 100 is held in front of the dog's head by a user. The user is placing their hands into the main channel 116 of the sleeve body 102 to hold the sleeve body 102 open. For example, the user in FIG. 4A may be expanding the sleeve body 102 from the first, or relaxed, configuration to the second, or expanded, configuration to fit over the dog's head.

FIG. 4B shows an image of the neck band 100 on the dog's neck with the dog's ear moved forward for visibility. The sleeve body 102 of the neck band 100 is folded or scrunched together near the dog's head with the esophagostomy tube 10 fully exposed. The outer surface 112 of the sleeve body 102 faces outward from the neck. Therefore, the neck band 100 is in the placement configuration, albeit without the esophagostomy tube 10 retained or coupled to the neck band 100.

FIG. 4C shows an image of the neck band 100 on the dog's neck wherein a user is flipping or folding a portion of the sleeve body 102 inside out to expose the inner surface 114 of the sleeve body 102. The flipping or folding of the sleeve body 102 also exposes the sheath 120. Thus, the neck band 100 is in the access configuration in FIG. 4C.

FIG. 4D shows an image of neck band 100 in the access configuration wherein the user is preparing to retain the esophagostomy tube 10 in the sheath 120. One of the user's hands is holding the esophagostomy tube 10 while the other user's hand is holding open the secondary channel 134 of the sheath 120.

FIG. 4E shows an image of the neck band 100 in the access configuration wherein the user is inserting the esophagostomy tube 10 into the sheath 120. In particular, the feeding adaptor 14 is disposed within the secondary channel 134 while a portion of the esophagostomy tube 10 remains outside the secondary channel 134 of the sheath 120.

FIG. 4F shows an image of the neck band 100 in the access configuration wherein the esophagostomy tube 10 has substantially all been inserted into the sheath 120. Thus, the esophagostomy tube 10 is fully retained and secured by the sheath 120.

FIG. 4G shows an image of the neck band 100 in the access configuration wherein the esophagostomy tube 10 is fully retained and secured by the sheath, similar to FIG. 4F. However, FIG. 4G also shows the user placing a gauze pad 16 on the surgical site (e.g., the stoma). The user may replace gauze pads or bandages when the neck band 100 is in the access configuration. The user may also apply disinfectant or antibiotics (e.g., medicinal gel or lotion) when the neck band 100 is in the access configuration.

FIG. 4H shows an image of neck band 100 in the placement configuration wherein the sleeve body 102 has been folded back over the esophagostomy tube 10. The outer surface 112 of the sleeve body 102 is visible, facing substantially outward from the dog's neck. In the configuration of FIG. 4H, the esophagostomy tube 10 is secured and retained by the neck band 100, and the dog can participate in daily activities.

### Configuration of Certain Implementations

The construction and arrangement of the systems and methods as shown in the various implementations are illustrative only. Although only a few implementations have been described in detail in this disclosure, many modifications are possible (e.g., variations in sizes, dimensions, structures, shapes, and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

Although the figures show a specific order of method steps, the order of the steps may differ from what is depicted. Also, two or more steps may be performed concurrently or with partial concurrence. All such variations are within the scope of the disclosure. It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

What is claimed is:

1. A device for retaining an implanted medical device, the device comprising:
a sleeve body extending circumferentially around a first longitudinal axis, the sleeve body defining a first aperture on a first end of the sleeve body and a second aperture on a second end of the sleeve body, wherein the second end is spaced apart longitudinally from the first end of the sleeve body; and
a sheath coupled to an inner surface of the sleeve body and extending circumferentially around a second longitudinal axis, the sheath defining a third aperture on a first end of the sheath and a fourth aperture on a second end of the sheath, wherein the second end of the sheath is spaced apart from the first end of the sheath.

2. The device of claim 1, wherein the first longitudinal axis is substantially perpendicular to the second longitudinal axis.

3. The device of claim 1, wherein the first longitudinal axis is transverse to the second longitudinal axis.

4. The device of claim 1, wherein the sleeve body extends continuously around the first longitudinal axis.

5. The device of claim 1, wherein the sleeve body comprises an integrally formed elastic fabric material.

6. The device of claim 1, wherein the sheath is configured to receive and retain an esophagostomy tube.

7. The device of claim 1, wherein the sheath is coupled to the inner surface of the sleeve body with at least one sewn thread.

8. The device of claim 1, wherein a circumference of the sleeve body measured around the first longitudinal axis is in a range of 9 to 20 inches.

9. The device of claim 1, wherein a height of the sleeve body measured from the first end to the second end of the sleeve body is in a range of 4 to 10 inches.

10. The device of claim 1, wherein the sleeve body comprises a stretchable, breathable fabric configured to slide over a head and onto a neck of an animal.

11. The device of claim 10, wherein the sleeve body is stretchable between:
(i) a first configuration having a first circumference measured along the sleeve body around the first longitudinal axis; and
(ii) a second configuration having a second circumference measured along the sleeve body around the first longitudinal axis,
wherein the second circumference is larger than the first circumference.

12. The device of claim 11, wherein a first height of the sleeve body measured from the first end to the second end of the sleeve body in the first configuration is greater than a second height of the sleeve body in the second configuration.

13. The device of claim 11, wherein the sleeve body is movable between:
(i) a placement configuration defined by the inner surface of the sleeve body being adjacent to the neck of the animal with an outer surface of the sleeve body facing away from the neck of the animal; and
(ii) an access configuration defined by a section of the sleeve body being folded outwardly from the first longitudinal axis to expose a portion of the inner surface of the sleeve body and the sheath.

14. The device of claim 13, wherein, in the access configuration, an esophagostomy tube may be inserted into or removed from the sheath and a surgical site may be inspected and cleaned.

15. The device of claim 1, wherein the sheath further comprises a cord stop configured to reduce a circumference of the first or second end of the sheath.

16. The device of claim 1, wherein the sleeve body further comprises a cord stop configured to reduce a circumference of the first or second end of the sleeve body.

17. The device of claim 1, wherein the first end of the sleeve body comprises an elastic member configured to reduce a circumference of the first end of the sleeve body.

18. The device of claim 1, wherein the sleeve body comprises a first portion adjacent to the first end of the sleeve body and a second portion in between the first and second ends of the sleeve body, wherein a first elasticity of the first portion is different than a second elasticity of the second portion.

19. The device of claim 1, wherein the sleeve body comprises a stretch woven fabric capable of at least 20% stretch in either warp or filling direction.

20. A method of retaining a medical device implanted on the neck of a living subject, the method comprising:
providing a retaining device, the device comprising:
a sleeve body extending circumferentially around a first longitudinal axis, the sleeve body defining a first aperture on a first end of the sleeve body and a second aperture on a second end of the sleeve body, wherein the second end is spaced apart longitudinally from the first end of the sleeve body; and
a sheath coupled to an inner surface of the sleeve body and extending circumferentially around a second longitudinal axis, the sheath defining a third aperture on a first end of the sheath and a fourth aperture on a second end of the sheath, wherein the second end of the sheath is spaced apart from the first end of the sheath,
placing the retaining device on a neck of an animal by stretching out a circumference of the sleeve body to fit over a head of the animal;
folding back a section of the sleeve body to expose a portion of the inner surface of the sleeve body and the sheath; and
inserting the medical device into the sheath.
